(19) United States
(12) Patent Application Publication
(10) Pub. No.: US 2010/0250215 A1
(43) Pub. Date: Sep. 30, 2010

(54) METHODS OF MODELING FLOW OF GAS WITHIN A RESERVOIR

(75) Inventors: Stephen R. Kennon, Austin, TX (US); Narayan Nair, Houston, TX (US); Arden McCracken, Houston, TX (US)

Correspondence Address: TOLER LAW GROUP, 8500 BLUFFSTONE COVE, SUITE A201, AUSTIN, TX, 78759, US

(73) Assignee: OBJECT RESERVOIR, INC., Houston, TX (US)

(21) Appl. No.: 12/413,671

(22) Filed: Mar. 30, 2009

(51) Int. Cl. G06G 7/57

(52) U.S. Cl. 703/10

(57) ABSTRACT

Methods of modeling flow of gas within a reservoir are provided. A particular method includes generating a representation of a gas reservoir, where the gas reservoir includes at least two phases of matter. The representation of the gas reservoir models the gas reservoir as a single phase. The method also includes modeling flow of gas within the gas reservoir using the representation.

### I. FIELD OF THE DISCLOSURE

The present disclosure is generally directed to method of modeling flow of gas within a reservoir.

### II. BACKGROUND

Reservoir simulation tools may be used to optimize economics, forecast production, evaluate the effectiveness of fractures, evaluate/compare/contrast different well completion strategies, and determine reserves, according to K. H. Coats, in “Reservoir Simulation,” Petroleum Engineers Handbook, January 1998. Blackoil simulation involves determining solutions to a set of partial differential equations. Certain reservoir simulation tools solve a three-dimensional, three phase mass balance to model the reservoir. The three phases are typically oil, water, and gas. The process of modeling fluid flow in reservoir simulation tools may become more complex and encounter numerical stability challenges as the number of phases being computed increases.

Particular difficulties may arise in modeling gas extracted from low-permeability sandstone and shale formations. In such reservoirs, the gas may include both adsorbed gas, (e.g., gas that forms a molecular monolayer on the walls of solids in the reservoir) and free gas (e.g., gas that exists in openings within the reservoir, such as pores). FIG. 1 schematically illustrates sources of gas in a shale or coalbed reservoir. A gas reservoir 102 has a network of fractures or cleats 104 in a solid matrix 106 (e.g., rock and/or other solids). Free gas may be present in the cleats 104. Magnification of the solid matrix 106 reveals a plurality of individual solid grains 107. Magnification of the solid grains 107 reveals a single grain with gas adsorbed to its surface and capable of being desorbed to form desorbed gas 110.

The gas can desorb from the solid matrix 106 or adsorb back onto the solid matrix 106 depending on conditions such as pressure and temperature. Often, blackoil equations assume that the reservoir 102 temperature is constant. With this assumption, the gas adsorption may be related to pressure by a “sorption isotherm.” According to A. C. Bumb and C. R. McKee, in “Gas-Well Testing in the Presence of Desorption for Coalbed Methane and Devonian Shale,” SPE 15227, SPE Formation Evaluation, March 1988, sorption in many reservoirs typically follows a Langmuir isotherm. FIG. 2 illustrates a typical Langmuir isotherm 200. Using the Langmuir isotherm two constants are needed to calculate the gas content at any pressure. For example, the gas content at pressure p may be calculated using

$$V = ( 0.031214 ) {V}_{m} \frac{p}{p + {p}_{L}} ,$$

where V is the volume of gas currently adsorbed at pressure p, Vₘ is Langmuir's volume constant (typically measured in units of standard cubic feet per ton,

$$\frac{scf}{ton} ) ,$$

and p_{L} is Langmuir's pressure (typically measured in units of pounds per square inch absolute, psia).

The Langmuir isotherm curve 200 may be considered to be analogous to a saturation curve and the gas content of the shale may be considered to equilibrate at a pressure when the gas content of the shale is equal to the gas content calculated using the Langmuir constants. Thus, the gas will desorb or adsorb to the solid matrix to achieve equilibrium. To illustrate, according to the Langmuir isotherm 200 shown in FIG. 2, a gas reservoir at about 4000 psia may have an adsorbed gas content of about

$$78 \frac{scf}{ton} ,$$

while a gas reservoir at about 2000 psia may have a gas content of the rock that is about

$$66 \frac{scf}{ton} .$$

Hence, if the pressure of the gas reservoir were reduced from about 4000 psia to about 2000 psia (e.g., by removing free gas), then about

$$12 \frac{scf}{ton}$$

of gas would be desorbed from the solid matrix.

The transport of the gas from the reservoir to a well may be considered to include a diffusion stage followed by Darcy flow. In the diffusion stage, a pressure gradient due to drawdown at the well causes gas to be desorbed from the solid matrix and to migrate through interconnected micro pores to a micro fracture network, such as the micro fracture network 104 shown in FIG. 1. According to J. P. Seidle and L. E. Arri (Seidle et al.), in “Use of Conventional Reservoir Models for Coalbed Methane Simulation,” SPE 21599, presented at the International Technical Meeting in Calgary, June 1990, the diffusion of gas in coalbed methane (CBM) reservoirs may typically be twice as fast as the Darcy flow. In the Darcy flow stage, gas is transported through the fracture network to the drainage well. The permeability of the fracture network may be measured and in a shale reservoir may typically range from about 0.01 milli-Darcy to 1 nano-Darcy.

Modeling reservoirs to account for adsorbed gas content is difficult or impossible with many reservoir simulators because typical reservoir simulators perform a mass balance calculation without taking into account a gas source term. One conventional approach to modeling such reservoirs has been the two phase approach. For example, Seidle et al. modeled gas desorption from coal as gas dissolved in immobile oil. The solution-gas ratio was calculated using the Langmuir isotherm constants. In this reservoir simulation, the solid matrix is modeled as oil, as shown in FIG. 3 at 300. The oil phase may be prevented from flowing by increasing the phase viscosity or by reducing the relative permeability of oil to zero. This procedure has been used as a proxy and benchmark in conventional reservoir simulation studies of coalbed reservoirs, according to G. W. Paul, W. K. Sawyer and R. H. Dean, in “Validation of 3D Coalbed Methane,” SPE 20733, presented at the 65^{th} ATCE in New Orleans, La., September 1990.

However, there are several shortcomings to this two phase approach. With respect to vertical equilibrium, it is difficult to maintain the same value of gas saturation in the entire depth of the reservoir. If the well is fractured, the fractures are initialized with immobile oil. With respect to the three phase physics problem, inclusion of fracture treatment water cleanup in the model requires three phase physics and two transition zones. With respect to mesh resolution, to accurately capture the pressure transient behavior, often an extremely refined mesh may be required. Coupled with at least two phase physics, the simulation process may get very computationally expensive, and sometimes even prohibitively expensive.

### III. SUMMARY

In a particular embodiment, a method is disclosed that includes generating a representation of a gas reservoir, where the gas reservoir includes at least two phases of matter. The representation of the gas reservoir models the gas reservoir as a single phase. The method also includes modeling flow of gas within the gas reservoir using the representation.

In another embodiment, a method is disclosed that includes generating a representation of a gas reservoir, where the representation of the gas reservoir includes a proxy system compression factor to model free gas and gas desorption in the gas reservoir. The method also includes modeling flow of gas within the gas reservoir using the representation.

In another embodiment, a method is disclosed that includes generating a representation of a gas reservoir, where the representation of the gas reservoir includes a proxy gas compression factor to model free gas and gas desorption in the gas reservoir. The method also includes generating a modified viscosity curve that is adjusted for the proxy gas compression factor and modeling flow of gas within the gas reservoir using the representation.

In another embodiment, a computer-readable medium is disclosed. The computer-readable medium has processor instructions that are executable to cause a processor to generate a single phase representation of a gas reservoir, where the gas reservoir includes at least free gas and gas adsorbed to a solid substrate. Characteristics of the single phase representation of the gas reservoir are selected to account for the free gas and to account for the adsorbed gas with respect to particular gas reservoir conditions.

Various aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a prior art diagram that schematically illustrates gas desorption in a reservoir;

FIG. 2 is a prior art diagram of a typical Langmuir isotherm;

FIG. 3 is a prior art diagram that schematically illustrates modeling a solid matrix as immobile oil;

FIG. 4 is a diagram of a particular illustrative embodiment of a method of modeling flow of gas within a reservoir;

FIG. 5 is a diagram of an embodiment of a reservoir;

FIG. 6 is a diagram of a first embodiment of a representation of a near-well region in a reservoir;

FIG. 7 is a diagram of a second embodiment of a representation of a near-well region in a reservoir;

FIG. 8 is a screen shot of a first embodiment of a reservoir simulator display;

FIG. 9 is screen shot of a second embodiment of a reservoir simulator display;

FIG. 10 is screen shot of a third embodiment of a reservoir simulator display;

FIG. 11 is a screen shot of a fourth embodiment of a reservoir simulator display;

FIG. 12 is a flow diagram of a first embodiment of a method of modeling flow of gas within a reservoir;

FIG. 13 is a flow diagram of a second embodiment of a method of modeling flow of gas within a reservoir;

FIG. 14 is a flow diagram of a third embodiment of a method of modeling flow of gas within a reservoir;

FIG. 15 is a flow diagram of a fourth embodiment of a method of modeling flow of gas within a reservoir; and

FIG. 16 is a diagram showing a comparison of techniques to simulate desorption.

### V. DETAILED DESCRIPTION

In various illustrative embodiments of the methods described herein (such as the method 400, the method 1200, the method 1400, and the method 1500) the representation that is generated may depend in part of the blackoil gas pseudo-component mass balance. The blackoil gas pseudo-component mass balance may be modified to include desorption as follows:

$$[ \frac{{u}_{gx}}{{B}_{g}} {\vert}_{x + Δ x , y , z} Δ t - \frac{{u}_{gx}}{{B}_{g}} {\vert}_{x , y , z} Δ t ] Δ y Δ z + [ \frac{{u}_{gy}}{{B}_{g}} {\vert}_{x , y + Δ y , z} Δ t - \frac{{u}_{gy}}{{B}_{g}} {\vert}_{x , y , z} Δ t ] Δ x Δ z [ \frac{{u}_{gz}}{{B}_{g}} {\vert}_{x , y , z + Δ z } Δ t - \frac{{u}_{gz}}{{B}_{g}} {\vert}_{x , y , z} Δ t ] Δ x Δ y = [ ( \frac{φ}{{B}_{g}} + V ) {\vert}_{t + Δ t} - ( \frac{φ}{{B}_{g}} + V ) {\vert}_{t} ] Δ x Δ y Δ z . \qquad ( 1 )$$

In Equation (1), u_{gx}, u_{gy} and u_{gz} are components of the gas velocity vector, \vec{u_{g}}, in the x, y and z directions, respectively, B_{g} is the formation volume factor, φ is the effective gas-filled porosity, and V is the volume of gas currently adsorbed at pressure p. In an illustrative embodiment, V is measured in units of

$$\frac{scf}{{ft}^{3}} ,$$

standard cubic feet per cubic foot. Dividing both sides of Equation (1) by ΔxΔyΔzΔt and taking the limits Δx→0, Δy→0, Δz→0, and Δt→0 gives:

$$∇ \cdot [ \frac{\vec{{u}_{g}}}{{B}_{g}} ] = \frac{\partial }{\partial t} ( \frac{φ}{{B}_{g}} + V ) . \qquad ( 2 )$$

Using Darcy's law that

$$\vec{{u}_{g}} = \frac{k}{{μ}_{g}} ( \vec{∇} {P}_{g} - {ρ}_{g} g \vec{∇} D ) ,$$

where k is the reservoir permeability, μ_{g} is the gas viscosity, P_{g} is the gas phase pressure, ρ_{g} is the gas density, g is gravitational acceleration, and D is the gravitational potential, turns Equation (2) into:

$$∇ \cdot [ \frac{k}{{μ}_{g} {B}_{g}} ( \vec{∇} {P}_{g} - {ρ}_{g} g \vec{∇} D ) ] = \frac{\partial }{\partial t} ( \frac{φ}{{B}_{g}} + V ) . \qquad ( 3 )$$

Equation (3) is the diffusivity equation or the blackoil equation for the gas phase with a source term to account for desorption. Consider Equation (3) for an initial porosity φ₁:

$$∇ \cdot [ \frac{k}{{μ}_{g} {B}_{g}} ( \vec{∇} {P}_{g} - {ρ}_{g} g \vec{∇} D ) ] = \frac{\partial }{\partial t} ( \frac{{φ}_{1}}{{B}_{g}} + V ) . \qquad ( 4 )$$

Consider Equation (3) for a modified porosity φ₂ without the desorption term:

$$∇ \cdot [ \frac{k}{{μ}_{g} {B}_{g}} ( \vec{∇} {P}_{g} - {ρ}_{g} g \vec{∇} D ) ] = \frac{\partial }{\partial t} ( \frac{{φ}_{2}}{{B}_{g}} ) . \qquad ( 5 )$$

Subject to the constraint that

$$( \frac{{φ}_{1}}{{B}_{g}} + V ) = ( \frac{{φ}_{2}}{{B}_{g}} ) ,$$

Equation (4) is equivalent to Equation (5). Solving the constraint equation gives:

φ₂=φ₁+VB_{g}. (6)

The porosity satisfies φ=φᵣ[1+cᵣ(p−pᵣ)]. The initial porosity φ₁, the volume V of the gas at pressure p, and the formation volume factor B_{g} are all functions of pressure. If solutions are found for the modified porosity φ₂ for all values of pressure, then a new set of pressure dependent porosity data may be generated that includes desorption. This is an example of a Pressure Dependent Porosity technique. Since the compressibility of the system cannot be negative, the gas compressibility should always exceed the pore volume compressibility at all pressures.

Consider Equation (3) for an initial gas viscosity μ_{g1} and an initial formation volume factor B_{g1}, assuming that the hydrostatic head due to gas (the term with the gas density ρ_{g} factor) is negligible (e.g., where water is present hydrostatic head due to gas may be significantly less than hydrostatic head due to the water):

$$∇ \cdot [ \frac{k}{{μ}_{g 1} {B}_{g 1}} ( \vec{∇} {P}_{g} ) ] = \frac{\partial }{\partial t} ( \frac{φ}{{B}_{g 1}} + V ) . \qquad ( 7 )$$

Consider Equation (7) for a modified gas viscosity μ_{g2} and a modified formation volume factor B_{g2} without desorption:

$$∇ \cdot [ \frac{k}{{μ}_{g 2} {B}_{g 2}} ( \vec{∇} {P}_{g} ) ] = \frac{\partial }{\partial t} ( \frac{φ}{{B}_{g 2}} ) . \qquad ( 8 )$$

Subject to the two constraints

$$( \frac{φ}{{B}_{g 1}} + V ) = ( \frac{φ}{{B}_{g 2}} ) and \frac{k}{{μ}_{g 1} {B}_{g 1}} = \frac{k}{{μ}_{g 2} {B}_{g 2}} ,$$

Equation (7) is equivalent to Equation (8). Solving the first constraint gives:

$${B}_{g 2} = ( \frac{φ}{( \frac{φ}{{B}_{g 1}} + V )} ) . \qquad ( 9 )$$

Solving the second constraint gives:

$${μ}_{g 2} = \frac{{μ}_{g 1} {B}_{g 1}}{{B}_{g 2}} . \qquad ( 10 )$$

The initial formation volume factor B_{g1}, the initial gas viscosity μ_{g1}, and the volume V of the gas at pressure p are all functions of pressure. If solutions are found for the modified formation volume factor B_{g2} and the modified gas viscosity μ_{g2} for all values of the pressure, then a new set of pressure, volume, and temperature (PVT) data may be generated that includes desorption. This is an example of a Formation Volume Factor technique.

Both the Pressure Dependent Porosity technique and the Formation Volume Factor technique include desorption into a single phase blackoil gas mass balance. The compressibility of the gas or the pore volume may be modified to account for the pressure dependent desorption term. The Formation Volume Factor technique assumes the hydrostatic head of gas is negligible. This assumption is more applicable in a gas-water model. The Pressure Dependent Porosity technique may be used for single phase gas cases.

Various illustrative embodiments of the methods described herein (such as the method 400, the method 1200, the method 1400, and the method 1500) allow for accurate modeling of shale gas systems using existing blackoil reservoir simulators, such as the Resolve reservoir modeling software available from Object Reservoir, Inc. of Houston, Tex. The Resolve reservoir modeling software combines static and dynamic data. The Resolve reservoir modeling software also merges geology, geophysical, and engineering technology that allows near-real-time drilling, completion, and stimulation decisions. For example, shale gas reservoirs are typically extremely low permeability and effective fracture treatment may be important to economic success. In the Resolve reservoir modeling software permeability and fracture design are co-dependent and a real-time integrated modeling approach may improve ultimate recovery. The Resolve reservoir modeling software uses the finite element method with adaptive meshing capability that can conform to reservoir geometries and automatically scale to the resolution that is useful. Using a true unstructured 3-D mesh gives a combination of speed and realism that may not be available in other tools.

In extremely low permeability reservoirs, adequate numerical resolution around a fracture face may be required to capture the non-linear pressure profile. To complicate the problem, desorption is also pressure dependent. Numerical solutions to partial differential equations, such as Equation (3), may be subject to mathematical convergence problems with increased resolution. In various illustrative embodiments of the methods described herein (such as the method 400, the method 1200, the method 1400, and the method 1500), mesh or grids may be in the inch-scale around a fracture to converge shale gas simulations. This level of refinement, without manual re-gridding, is available using the Resolve reservoir modeling software. Particular embodiments of the methods described herein (such as the method 400, the method 1200, the method 1400, and the method 1500) may provide an order of magnitude increase in computational speed with respect to multi-phase gas reservoir modeling. The single phase desorption approach disclosed in particular embodiments herein may be usefully coupled with the unstructured mesh technology that offers extreme localized numerical resolution to capture the transport of gas in shales, for example.

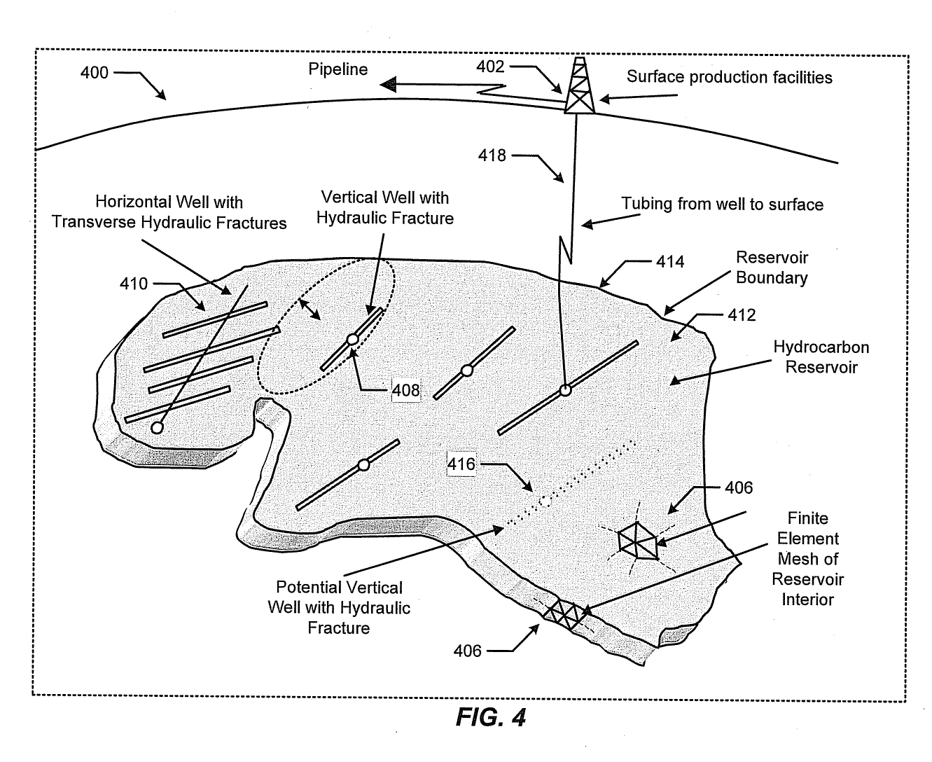

Referring to FIG. 4, a diagram of a particular illustrative embodiment of a method of modeling flow of gas within a reservoir is depicted and generally designated 400. The method 400 may include generating a representation of a gas reservoir 412, where the gas reservoir 412 includes at least two phases of matter. The representation of the gas reservoir 412 may model the gas reservoir 412 as a single phase. The method 400 may also include modeling flow of gas within the gas reservoir 412 using the representation. A finite element mesh 406 of the interior of the gas reservoir 412 may be used to model flow of gas within the gas reservoir 412. The representation may include a plurality of finite element numerical expressions descriptive of fluid behavior in the gas reservoir 412. The plurality of finite element numerical expressions may be formulated and computed using the finite element mesh 406. Modeling the flow of gas within the gas reservoir 412 using the representation may include determining at least one solution to at least one of the plurality of finite element numerical expressions.

The representation of the gas reservoir 412 may be used to model flow of gas within the reservoir 412 and via tubing 418 of a well to surface production facilities 402. The representation of the gas reservoir 412 may be bounded by a reservoir boundary 414 defining a region in which the finite element mesh resides. The representation of the gas reservoir 412 may model vertical wells 408, horizontal wells 410, or any combination thereof. Additionally, either the vertical wells 408 or the horizontal wells 410 may include hydraulic fractures. For example, the horizontal wells 410 may include transverse hydraulic fractures. The representation of the gas reservoir 412 may also model one or more planned or proposed wells, such as a potential vertical well with a hydraulic fracture 416.

By using the method 400, high fidelity reservoir models may be simulated with much less computation and with greater computational stability than traditionally used formulations in tight gas reservoirs, while maintaining comparable accuracy. In addition, by using the method 400, an efficient and computationally inexpensive methodology may be provided to model the transport of gas in gas reservoirs, such as shale reservoirs. Further, by using the method 400, modeling techniques are made available that reduce the number of phases and the computational complexity, resulting in significant reductions in the run-times of the models and greater flexibility in the types of reservoirs that can be successfully modeled.

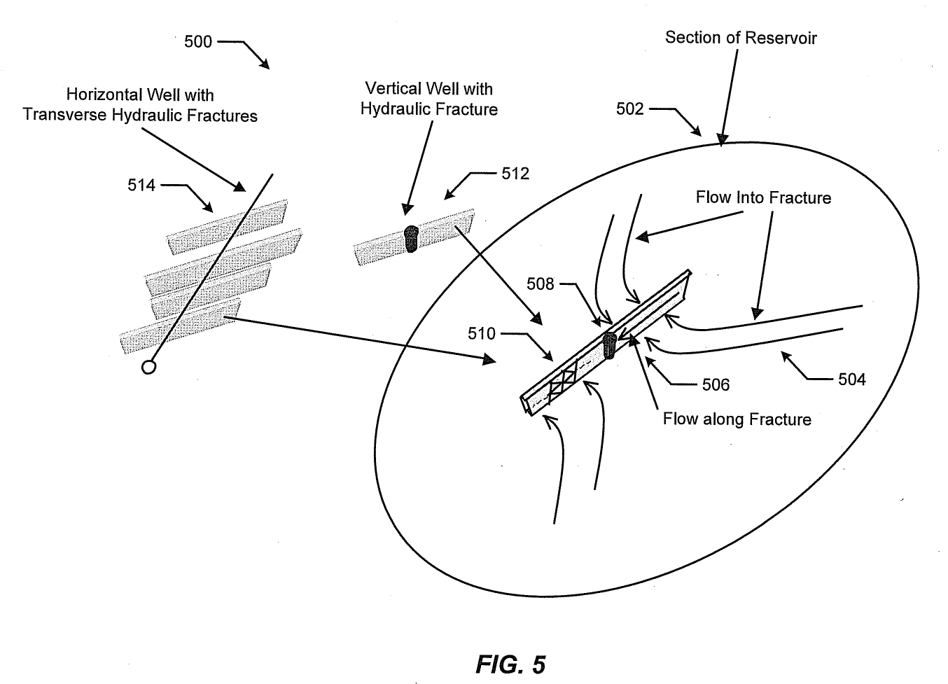

Referring to FIG. 5, a diagram of an embodiment of a reservoir is depicted and generally designated 500. The reservoir includes one or more wells, and each of the one or more wells may include hydraulic fractures. For simplicity of explanation, a section of the reservoir 512 including a well 508 is illustrated. The well 508 may be a horizontal well, a vertical well, a horizontal well with transverse hydraulic fractures 514, a vertical well with hydraulic fractures 512, or any combination thereof. In the embodiment illustrated, the well 508 includes a hydraulic fracture 510. Gas flow into the hydraulic fracture 510 is indicated at 504. For example, the gas may flow through a solid medium within the reservoir, such as shale, via diffusion. Gas flow along the hydraulic fracture is indicated at 506. The gas flows into a wellbore 508 is modeled via finite element connections 510.

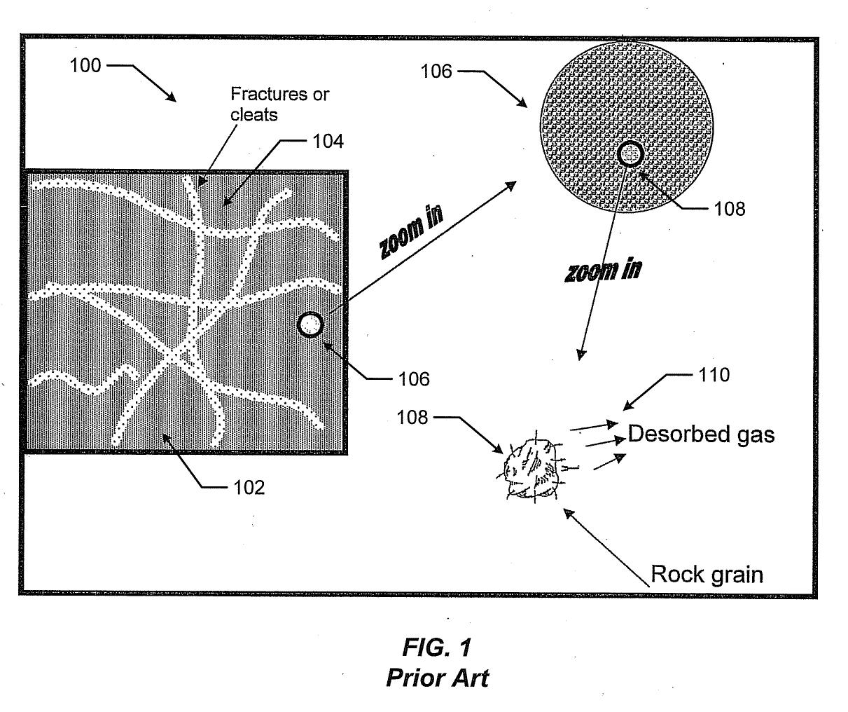

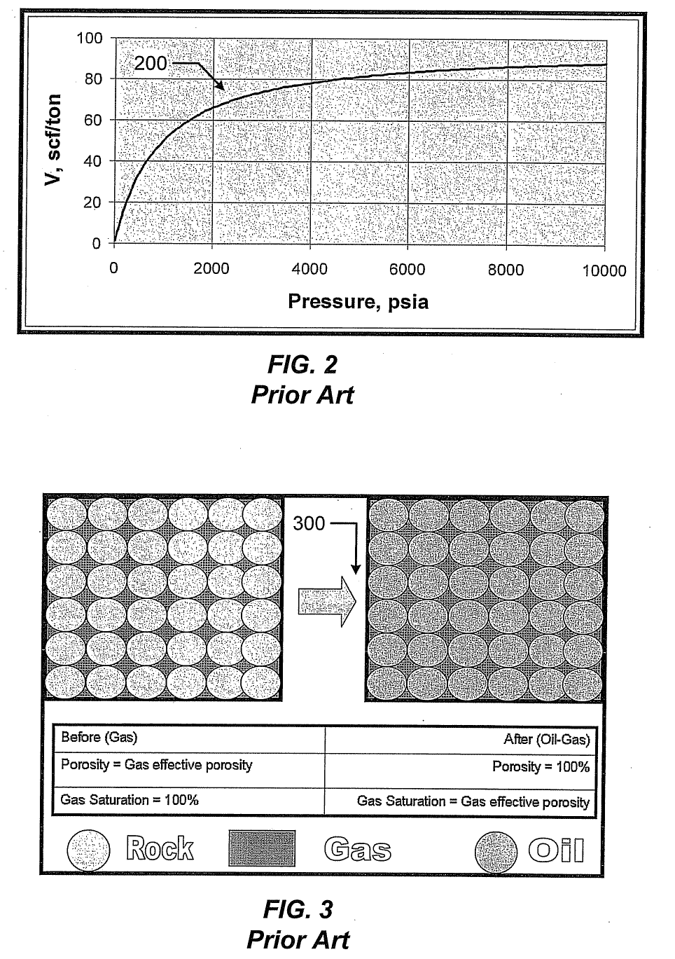

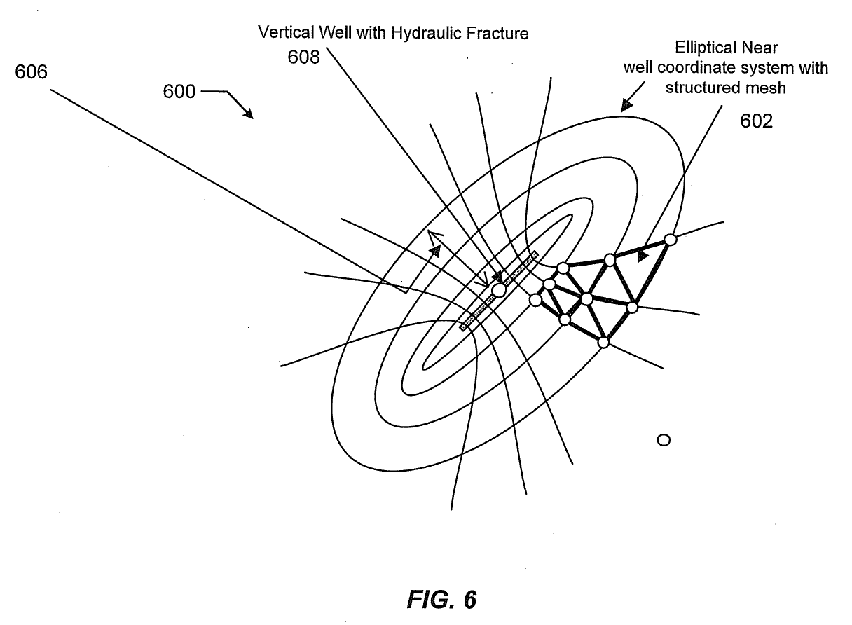

Referring to FIG. 6, a diagram of a first embodiment of a representation of a near-well region is depicted and generally designated 600. The representation of the near-well region 600 includes an elliptical near-well coordinate system with an unstructured mesh 602. The representation of the near-well region 600 includes a minor-axis distance 606 that defines the near-well region 600. The minor-axis distance 606 may be specified by a user to define the near-well region 600. The representation of the near-well region 600 also includes a vertical well with a hydraulic fracture 608. The unstructured mesh 602 may be a finer mesh than is used to define a bulk of the reservoir, such as the finite element mesh 106 described with reference to FIG. 1. Additionally, the unstructured mesh may be smoothly connected to a courser unstructured mesh in a representation of the reservoir surrounding the near-well region.

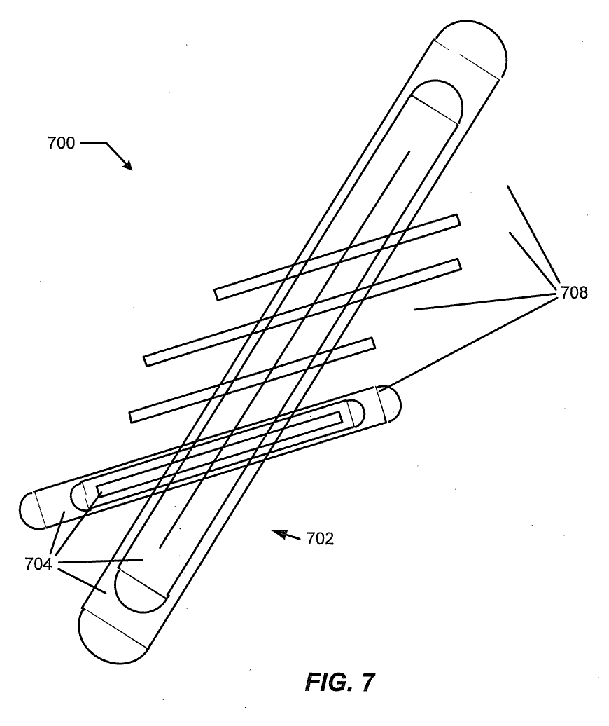

Referring to FIG. 7, a diagram of a second embodiment of a representation of a near-well region is depicted and generally designated 700. The representation of the near-well region 700 includes a horizontal well with hydraulic fractures 702. The representation of the near-well region 700 also includes rings 704 indicating a near-well coordinate system. An unstructured mesh, similar to the unstructured mesh 602 discussed with reference to FIG. 6 may be included in the near-well region 700. Mesh spacing of the unstructured mesh may be specified by a user, for example, by specifying a number and/or spacing of the rings 704. The unstructured mesh may be automatically generated to substantially conform to physical dimensions of defined by the user and to smoothly connect to a courser unstructured mesh in a representation of the reservoir surrounding the near-well region 700.

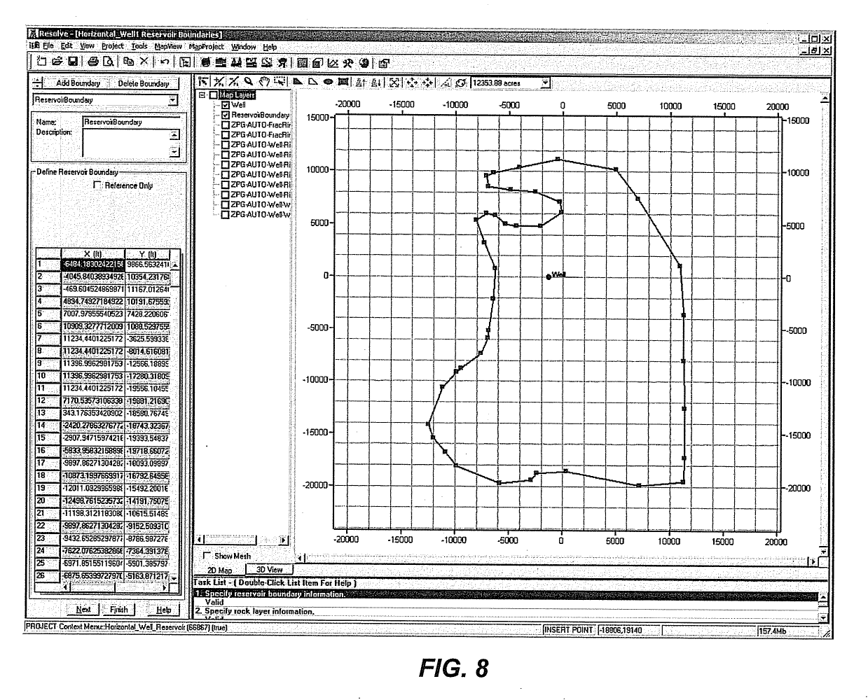

Referring to FIG. 8, a screen shot of a first embodiment of a reservoir simulator display is shown. The reservoir simulator display may be used to generate a representation of a reservoir. For example, information defining a reservoir boundary, information defining a location or type of a wellbore, other information describing physical parameters of the reservoir, or any combination thereof may be input by a user via the reservoir simulator display.

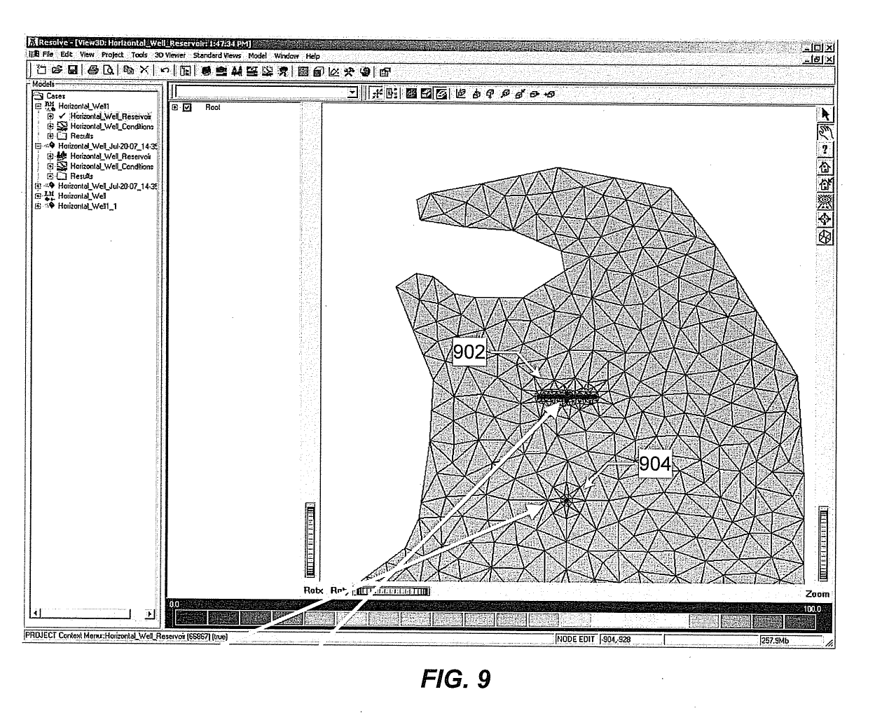

Referring to FIG. 9, a screen shot of a second embodiment of a reservoir simulator display. The reservoir simulator display illustrates defining an unstructured mesh within the representation of the reservoir. The reservoir simulator display shows an unstructured mesh filling the representation of the reservoir, a first near-well unstructured mesh within a radial near-well region 904 around a vertical well, and a second near-well unstructured mesh within a near-well region 902 around a horizontal well. The near-well meshes may have a finer resolution than the rest of the unstructured mesh within the representation of the reservoir. Additionally, the near-well mesh may be smoothly embedded in the unstructured mesh of the rest of the representation of the reservoir.

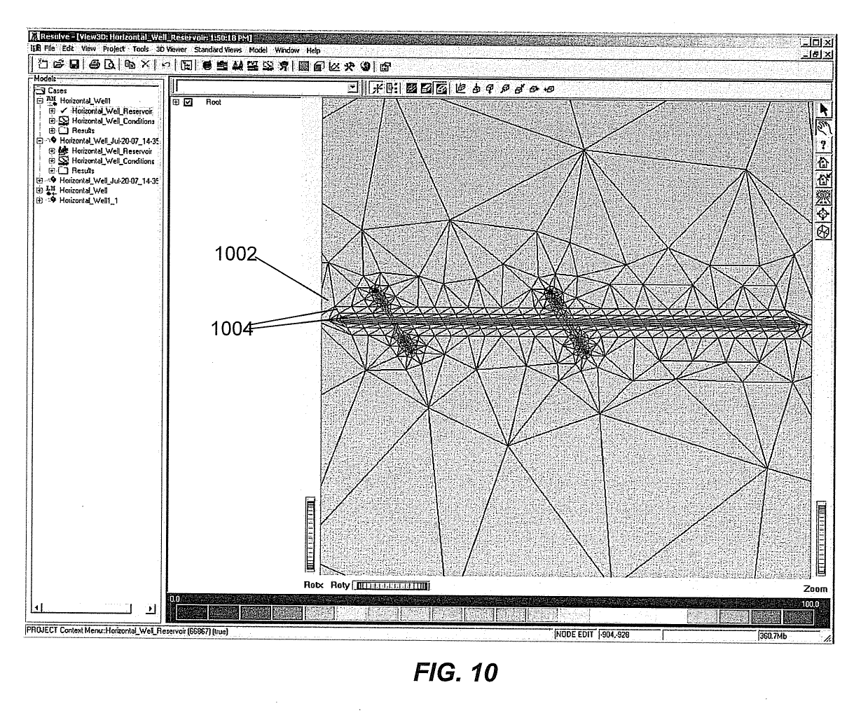

Referring to FIG. 10, a screen shot of a third embodiment of a reservoir simulator display. The reservoir simulator display includes a closer view of the near-well region around a horizontal well with transverse fractures, such as the near-well region 902 illustrated in FIG. 9. In particular, the reservoir simulator display shows a course reservoir unstructured mesh 1002 within the bulk of the representation of the reservoir and a finer near-well mesh 1004 around horizontal well with transverse fractures. The reservoir simulator display also shows the near-well mesh 1004 smoothly embedded with the course reservoir mesh. 1002.

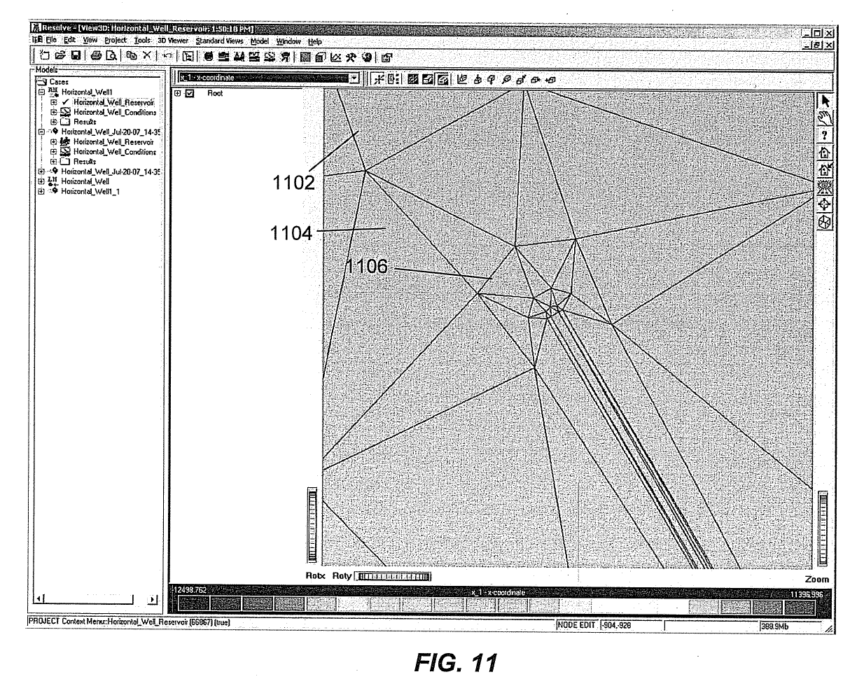

Referring to FIG. 11, a screen shot of a fourth embodiment of a reservoir simulator display. The reservoir simulator display shows a close-in view of a transition between a course reservoir mesh 1102 and a near-well mesh 1106, e.g., a mesh inside a transverse fracture. In particular, the reservoir simulator display shows that the near-well mesh 1106 is smooth embedded in the course reservoir mesh 1102 with a boundary between the two defined by a ring 1104 (such as the rings 704 discussed with reference to FIG. 7 or the elliptical coordinate system 602 discussed with reference to FIG. 6).

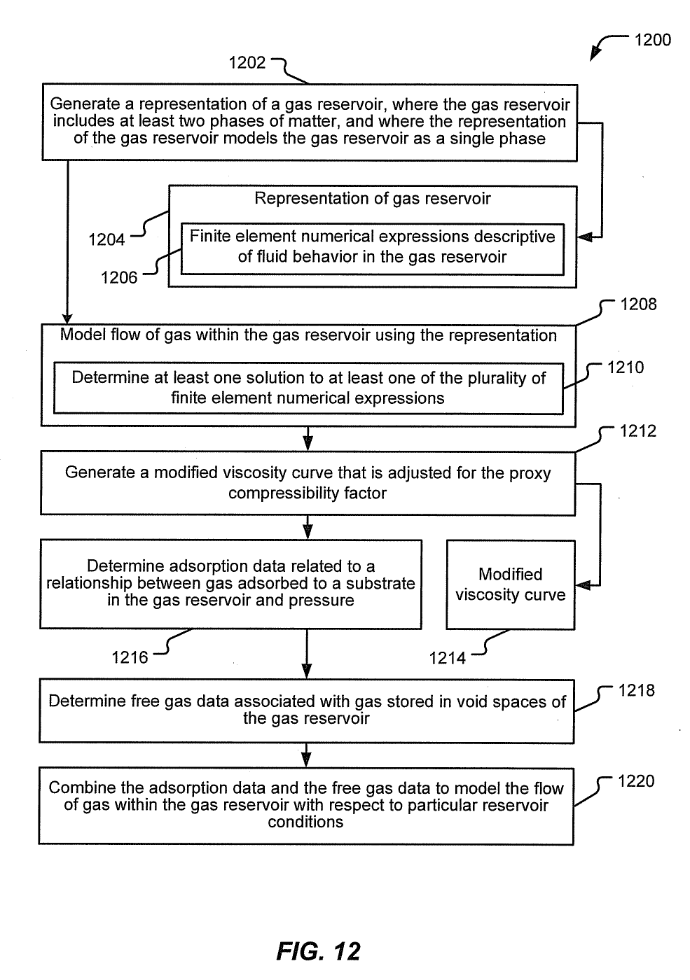

Referring to FIG. 12, a flow diagram of a particular illustrative embodiment of a method of modeling flow within a gas reservoir is depicted and generally designated 1200. The method 1200 includes, at 1202, generating a representation 1204 of a gas reservoir, where the gas reservoir includes at least two phases of matter, and where the representation of the gas reservoir models the gas reservoir as a single phase. In a particular embodiment, the single phase may be a hydrocarbon gas. The representation 1202 of the gas reservoir may include a plurality of finite element numerical expressions descriptive of fluid behavior in the gas reservoir 1206. The method 1200 also includes, at 1208, modeling flow of gas within the gas reservoir using the representation 1202. Modeling the flow of gas within the gas reservoir using the representation may include, at 1210, determining at least one solution to at least one of the plurality of finite element numerical expressions.

The method 1200 may include, at 1212, generating a modified viscosity curve 1214 that is adjusted for a proxy compressibility factor. The flow of gas within the gas reservoir may be modeled based on the modified viscosity curve. The method 1200 may include, at 1216, determining adsorption data related to a relationship between gas adsorbed to a substrate in the gas reservoir and pressure. In a particular embodiment, the adsorption data may include Langmuir isotherm data. In a particular embodiment, the substrate may include tar. In another particular embodiment, the substrate may include porous media with adsorbed gas. For example, the porous media may include shale, coal, another porous media, or any combination thereof. The method 1200 may include, at 1218, determining free gas data associated with gas stored in void spaces of the gas reservoir. The method 1200 may include, at 1220, combining the adsorption data and the free gas data to model the flow of gas within the gas reservoir with respect to particular reservoir conditions.

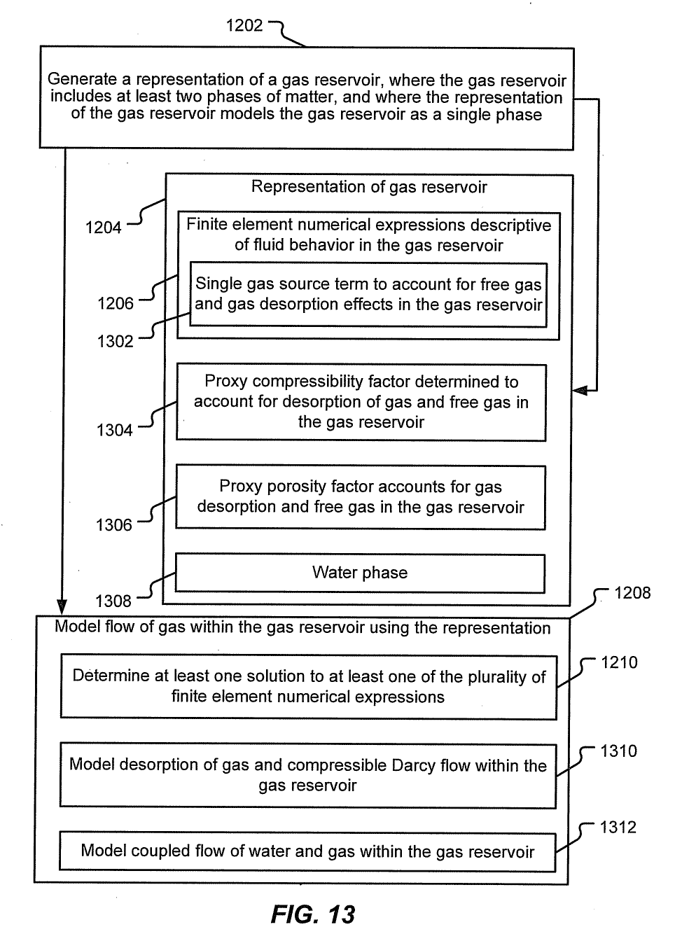

Referring to FIG. 13, a flow diagram of a second embodiment of a method of modeling flow of gas within a reservoir. The method illustrated in FIG. 13 includes portions the method 1200, discussed with reference to FIG. 12, shown in more detail. In a particular embodiment, at least one of the plurality of finite element numerical expressions 1206 may include a single gas source term to account for free gas and gas desorption effects in the gas reservoir 1302. The representation of the gas reservoir 1204 may include a proxy compressibility factor 1304. The proxy compressibility factor 1304 may be determined to account for desorption of gas and free gas in the gas reservoir. As described above with reference to FIG. 12, the method 1200 may include generating a modified viscosity curve that is adjusted for the proxy compressibility factor 1304. In a particular embodiment, the flow of gas within the gas reservoir may be modeled based on the modified viscosity curve.

In a particular embodiment, the representation of the gas reservoir 1204 may include a proxy porosity factor 1306, as discussed above with reference to Equations 3-6. The proxy porosity factor 1306 may account for gas desorption and free gas in the gas reservoir and modeling the flow of gas within the gas reservoir using the representation 1204 may include, at 1310, modeling desorption of gas and compressible Darcy flow within the gas reservoir.

In another particular embodiment, the representation of the gas reservoir 1204 may include a water phase 1308 and modeling the flow of gas within the gas reservoir may include, at 1312, modeling a coupled flow of water and gas within the gas reservoir.

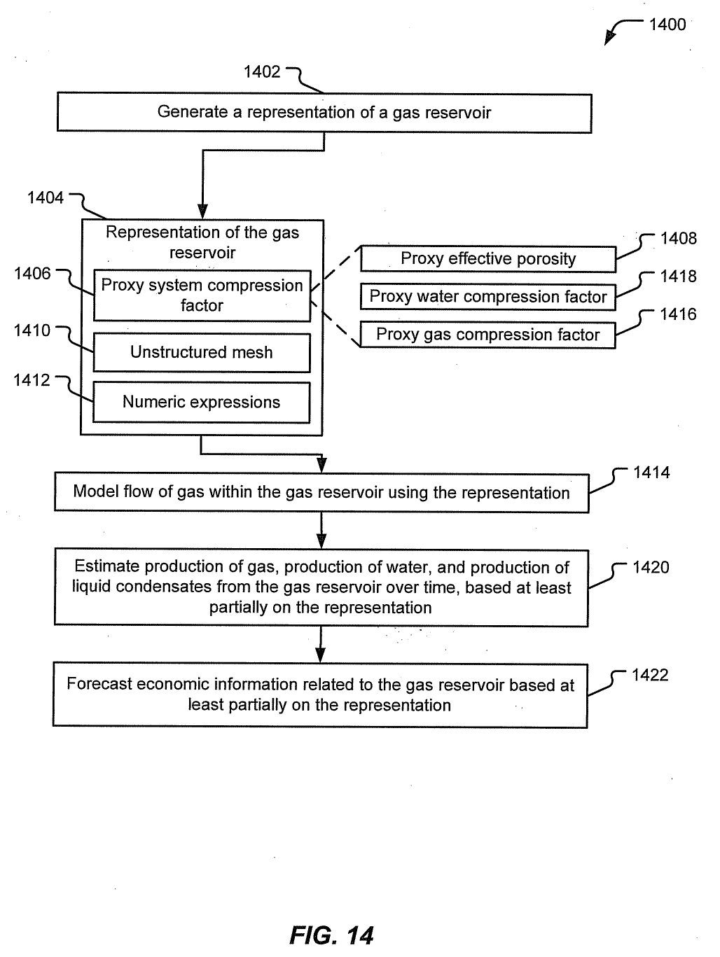

Referring to FIG. 14, a flow diagram of a third embodiment of a method of modeling flow of gas within a reservoir is shown and generally designated 1400. The method 1400 includes, at 1402, generating a representation 1404 of a gas reservoir. In a particular embodiment, the representation 1404 of the gas reservoir includes a proxy system compression factor 1406 to model free gas and gas desorption in the gas reservoir, as discussed above with reference to Equations 3, and 7-10. In an illustrative embodiment, the proxy system compression factor 1406 may include a proxy effective porosity 1408 of a substrate of the gas reservoir. The proxy effective porosity 1408 may be different than a measured porosity associated with the gas reservoir.

In another particular embodiment, the proxy system compression factor 1406 may include a proxy gas compression factor 1416 of the gas of the gas reservoir. In another particular embodiment, the proxy system compression factor 1406 may include a proxy water compression factor 1418 of a water phase of the gas reservoir.

The representation 1404 of the gas reservoir may include an unstructured mesh 1410. The unstructured mesh 1410 may correspond to geometric features of the gas reservoir. Further, the representation 1404 of the gas reservoir may include a plurality of numeric expressions 1412 associated with the unstructured mesh. The numerical expressions 1412 may be descriptive of flow in the gas reservoir.

The method 1400 also includes modeling flow of gas within the gas reservoir using the representation 1404. The method 1400 may also include, at 1420, estimating the production of gas, the production of water, and the production of liquid condensates from the gas reservoir over time, based at least partially on the representation. In a particular embodiment, the method 1400 includes, at 1422, forecasting economic information related to the gas reservoir based at least partially on the representation.

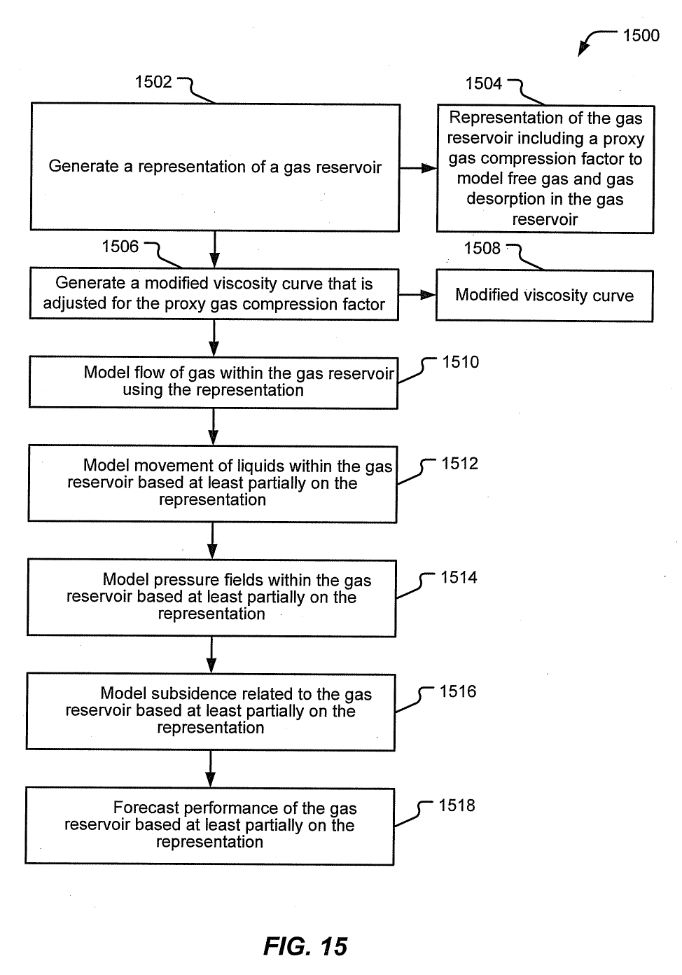

Referring to FIG. 15, a flow diagram of a fourth embodiment of a method of modeling flow of gas within a reservoir is depicted and generally designated 1500. The method 1500 includes, at 1502, generating a representation 1504 of a gas reservoir. The representation 1504 of a gas reservoir may include a proxy gas compression factor to model free gas and gas desorption in the gas reservoir. The method 1500 also includes, at 1506, generating a modified viscosity curve 1508 that is adjusted for the proxy gas compression factor. The method 1500 also includes, at 1510, modeling flow of gas within the gas reservoir using the representation. In a particular embodiment, the gas reservoir may include at least porous media, hydrocarbon fluids, and water.

The method 1500 may include, at 1512, modeling movement of liquids within the gas reservoir based at least partially on the representation 1504. The method 1500 may include, at 1514, modeling pressure fields within the gas reservoir based at least partially on the representation 1504. The method 1500 may include, at 1516, modeling subsidence related to the gas reservoir based at least partially on the representation 1504. The method 1500 may include, at 1518, forecasting performance of the gas reservoir based at least partially on the representation 1504.

In a particular embodiment, a computer-readable medium may be provided. The computer-readable medium may have processor instructions that are executable to cause a processor to generate a single phase representation of a gas reservoir. The gas reservoir may include at least free gas and gas adsorbed to a solid substrate. Characteristics of the single phase representation of the gas reservoir may be selected to account for the free gas and to account for the adsorbed gas with respect to particular gas reservoir conditions. The solid substrate may include porous media. For example, the porous media may include shale or coal.

The computer-readable medium may include instructions executable by the processor to model flow of gas within the gas reservoir based at least partially on the single phase representation. The computer-readable medium may also include instructions executable by the processor to estimate production of gas, production of water, and production of liquid condensates from the gas reservoir over time based at least partially on the single phase representation. The computer-readable medium may also include instructions executable by the processor to forecast economic information related to the gas reservoir based at least partially on the single phase representation.

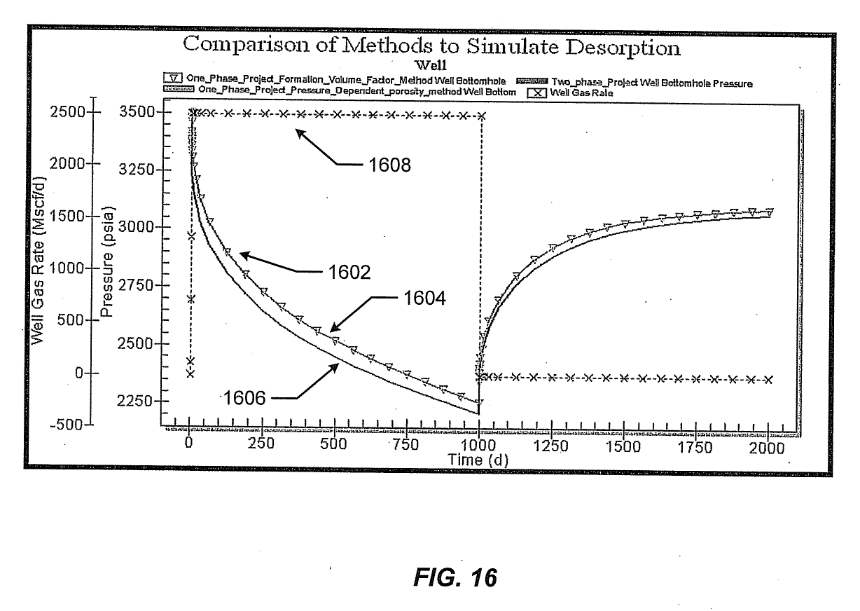

Referring to FIG. 16, a comparison of techniques to simulate desorption is shown. The well bottomhole pressure, measured in pounds per square inch absolute (psia), for the single phase Formation Volume Factor technique plotted against time (days) is indicated by the triangles 1602. The well bottomhole pressure (psia) for the single phase Pressure Dependent Porosity technique plotted against time (days) is indicated at 1604. For the sake of comparison, the well bottomhole pressure (psia) for a two phase technique plotted against time (days) is indicated at 1606. The well gas rate, measured in millions of standard cubic feet per day

$$( \frac{Mscf}{d} )$$

plotted against time (days) is indicated at 1608. The reservoir and well data for this simulation are as follows: reservoir area=640 acres, centered horizontal well length=2000 ft, isotropic permeability=0.1 mD (milliDarcy), gas effective porosity=0.0405,

$$compressibility = \frac{{10}^{- 8}}{psia} , Langmuir volume = 102.7 \frac{scf}{ton} ,$$

Langmuir pressure=914.9 psia, residual water saturation=0, gas gravity=0.7, and layer thickness=100 ft.

The methods described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disk read-only memory (CD-ROM), or any other form of computer readable storage medium. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
generating a representation of a gas reservoir, wherein the gas reservoir includes at least two phases of matter, and wherein the representation of the gas reservoir models the gas reservoir as a single phase; and
modeling flow of gas within the gas reservoir using the representation.

2. The method of claim 1, wherein the representation comprises a plurality of finite element numerical expressions descriptive of fluid behavior in the gas reservoir, and wherein modeling the flow of gas within the gas reservoir using the representation comprises determining at least one solution to at least one of the plurality of finite element numerical expressions.

3. The method of claim 2, wherein at least one of the plurality of finite element numerical expressions includes a single gas source term to account for free gas and gas desorption effects in the gas reservoir.

4. The method of claim 1, wherein the representation of the gas reservoir comprises a proxy compressibility factor, wherein the proxy compressibility factor is determined to account for desorption of gas and free gas in the gas reservoir.

5. The method of claim 4, further comprising generating a modified viscosity curve that is adjusted for the proxy compressibility factor, wherein the flow of gas within the gas reservoir is based on the modified viscosity curve.

6. The method of claim 1, wherein the representation of the gas reservoir comprises a proxy porosity factor, wherein the proxy porosity factor accounts for gas desorption and free gas in the gas reservoir.

7. The method of claim 6, wherein modeling the flow of gas within the gas reservoir using the representation comprises modeling desorption of gas and compressible Darcy flow within the gas reservoir.

8. The method of claim 1, wherein the representation of the gas reservoir includes a water phase, and wherein modeling the flow of gas within the gas reservoir comprises modeling a coupled flow of water and gas within the gas reservoir.

9. The method of claim 1, wherein the single phase is a hydrocarbon gas.

10. The method of claim 1, wherein modeling the flow of gas within the gas reservoir comprises:
determining adsorption data related to a relationship between gas adsorbed to a substrate in the gas reservoir and pressure;
determining free gas data associated with gas stored in void spaces of the gas reservoir; and
combining the adsorption data and the free gas data to model the flow of gas within the gas reservoir with respect to particular reservoir conditions.

11. The method of claim 10, wherein the adsorption data comprises Langmuir isotherm data.

12. The method of claim 10, wherein the substrate comprises tar.

13. The method of claim 10, wherein the substrate comprises porous media with adsorbed gas.

14. The method of claim 13, wherein the porous media comprises shale.

15. The method of claim 13, wherein the porous media comprises coal.

16. A method comprising:
generating a representation of a gas reservoir, wherein the representation of the gas reservoir includes a proxy system compression factor to model free gas and gas desorption in the gas reservoir; and
modeling flow of gas within the gas reservoir using the representation.

17. The method of claim 16, wherein the proxy system compression factor comprises a proxy effective porosity of a substrate of the gas reservoir.

18. The method of claim 17, wherein the proxy effective porosity is different than a measured porosity associated with the gas reservoir.

19. The method of claim 16, wherein the representation of the gas reservoir includes an unstructured mesh corresponding to geometric features of the gas reservoir, and a plurality of numeric expressions associated with the unstructured mesh and descriptive of flow in the gas reservoir.

20. The method of claim 16, wherein the proxy system compression factor comprises a proxy gas compression factor of the gas of the gas reservoir.

21. The method of claim 16, wherein the proxy system compression factor comprises a proxy water compression factor of a water phase of the gas reservoir.

22. A method comprising:
generating a representation of a gas reservoir, wherein the representation of the gas reservoir includes a proxy gas compression factor to model free gas and gas desorption in the gas reservoir;
generating a modified viscosity curve that is adjusted for the proxy gas compression factor; and
modeling flow of gas within the gas reservoir using the representation.

23. The method of claim 22, wherein the gas reservoir includes at least porous media, hydrocarbon fluids, and water.

24. The method of claim 22, further comprising:
modeling movement of liquids within the gas reservoir based at least partially on the representation;
modeling pressure fields within the gas reservoir based at least partially on the representation; and
modeling subsidence related to the gas reservoir based at least partially on the representation.

25. The method of claim 22, further comprising forecasting performance of the gas reservoir based at least partially on the representation.

26. A computer-readable medium having processor instructions that are executable to cause a processor to:
generate a single phase representation of a gas reservoir, wherein the gas reservoir includes at least free gas and gas adsorbed to a solid substrate, and wherein characteristics of the single phase representation of the gas reservoir are selected to account for the free gas and to account for the adsorbed gas with respect to particular gas reservoir conditions.

27. The computer-readable medium of claim 26, wherein the solid substrate comprises porous media.

28. The computer-readable medium of claim 27, wherein the porous media comprises shale.

29. The computer-readable medium of claim 27, wherein the porous media comprises coal.

30. The computer-readable medium of claim 26, further comprising instructions executable by the processor to model flow of gas within the gas reservoir based at least partially on the single phase representation.

31. The computer-readable medium of claim 26, further comprising instructions executable by the processor to estimate, based at least partially on the single phase representation, production of gas, production of water, and production of liquid condensates from the gas reservoir over time.

32. The computer-readable medium of claim 26, further comprising instructions executable by the processor to forecast economic information related to the gas reservoir based at least partially on the single phase representation.
